(19) United States
(12) Patent Application Publication
(10) Pub. No.: US 2026/0042382 A1
(43) Pub. Date: Feb. 12, 2026

(54) CARRIER AND CHILD SAFETY SEAT

(71) Applicant: Wonderland Switzerland AG, Steinhausen (CH)

(72) Inventor: Ganqing FANG, Dongguan (CN)

(73) Assignee: Wonderland Switzerland AG, Steinhausen (CH)

(21) Appl. No.: 19/296,076

(22) Filed: Aug. 11, 2025

(30) Foreign Application Priority Data
Aug. 12, 2024 (CN) 202411104146.0

(51) Int. Cl. B60N 2/28

(52) U.S. Cl. CPC B60N 2/2818; B60N 2/2812

(57) ABSTRACT

A carrier and a child safety seat including a seat, which includes a backrest part and a seat part provided with restraint strap holes; and a restraint strap mechanism, which seat part includes a restraint strap, an adjusting component, and a locking component; the restraint strap is threaded through the restraint strap hole, and the upper end of the restraint strap is connected to a first buckle, while the lower end is connected to a connecting member; the adjusting component is arranged inside the seat part and includes a connecting member which is able to slide along the guiding surface to change the length of the restraint strap extending out of the restraint strap hole and a guiding member with a guiding surface that extends obliquely from front to rear and downward; the locking component is arranged on the seat part to position the connecting member on the guiding surface.

### CROSS-REFERENCE TO RELATED APPLICATIONS

This application claims priority to Chinese Application No. 202411104146.0, entitled “CARRIER AND CHILD SAFETY SEAT” and filed on Aug. 12, 2024, which is incorporated herein by reference in its entirety.

### TECHNICAL FIELD

The present disclosure relates to the field of carrier technology, particularly to a carrier and a child safety seat.

### BACKGROUND

Child safety seats provide convenience and safety for children traveling by car. To adapt to children of different body sizes, child safety seats usually adopt a design where the length and position of the restraint strap can be adjusted, so that the restraint strap can be adjusted to be suitable for children of different body sizes.

### SUMMARY

One of the main objectives of the present disclosure is to overcome at least one of the drawbacks of the prior art and provide a carrier and a child safety seat with adjustable restraint strap mechanism, simple structure, and easy operation.

To achieve the above objectives, the present disclosure adopts the following technical solutions:

According to one aspect of the present disclosure, there is provided a carrier comprising a carrier body and a woven strap adjustment mechanism. Wherein, the carrier body is equipped with a woven strap hole. The woven strap adjustment mechanism includes a woven strap, an adjusting component, and a locking component. The woven strap is threaded through the woven strap hole, with an upper end of the woven strap exposed to the outside of the carrier body and a lower end located inside the carrier body, and is connected to the connecting member of the adjusting component; the adjusting component is set inside the carrier body and includes a connecting member and a guiding member; the guiding member has a guiding surface that extends obliquely from front to rear and downward, and the connecting member can slide along the guiding surface to change the length of the woven strap extending out of the woven strap hole. The locking component is set inside or outside the carrier body, and is used to position the connecting member in an operable manner on the guiding surface.

According to an embodiment of the present disclosure, the carrier may be a child safety seat, a child stroller, or a pet cage.

According to one aspect of the present disclosure, there is provided a child safety seat comprising a seat and a restraint strap mechanism; the seat comprises a seat part and a backrest part, and the seat part is provided with a restraint strap hole; the restraint strap mechanism comprises a restraint strap, an adjusting component, and a locking component; the restraint strap is threaded through the restraint strap hole, and the upper end of the restraint strap is connected to a first buckle, while the lower end thereof is connected to a connecting member described later; the adjusting component is set inside the seat part and includes the connecting member and a guiding member; the guiding member has a guiding surface that extends obliquely from front to rear and downward, and the connecting member can slide along the guiding surface to change the length of the restraint strap extending out of the restraint strap hole; the locking component is set on the seat part for positioning the connecting member on the guiding surface.

According to an embodiment of the present disclosure, the guiding member comprises a guiding seat, which is provided on the carrier body and has a first guiding slot, the first guiding slot extends obliquely from front to rear and downward, and the guiding surface is on the inner peripheral wall of the first guiding slot; the connecting member comprises a connecting rod, which is threaded through the first guiding slot and can slide along the first guiding slot.

According to an embodiment of the present disclosure, the locking component comprises a first gear and a first rack that engage with each other, the first gear is coaxially arranged on the connecting rod, and the first rack is arranged on the carrier body and extends obliquely from front to rear and downward. When the first gear rotates along the first rack, the connecting rod slides along the first guiding slot.

According to an embodiment of the present disclosure, an operating member is provided on the connecting rod, and the carrier body is provided with a first through slot. The extension direction of the first through slot is parallel to the extension direction of the first guiding slot, and a part of the operating member is exposed to the carrier body through the first through slot. The operating member is used for user operation to drive the connecting rod to pivot, so that the connecting rod slides along the first guiding slot.

According to an embodiment of the present disclosure, the connecting rod is connected to a second rack, which is movable on the guiding seat; the adjusting component further comprises an operating member, which is rotatably arranged on the guiding seat, and is coaxially arranged with a second gear, which engages with the second rack; when the user operates the operating member, the second gear rotates and drives the second rack to move, so that the connecting rod slides along the first guiding slot.

According to an embodiment of the present disclosure, the adjusting component further comprises a sliding seat, which is set in the guiding seat and can slide in the front-rear direction. The sliding seat is provided with a second guiding slot, and the extension direction of the second guiding slot is perpendicular to the seat surface of the carrier body; the connecting rod is further threaded through the second guiding slot and can slide along the second guiding slot.

According to an embodiment of the present disclosure, the locking component comprises a claw and a woven strap; the claw is movably provided on the sliding seat and has a locking position and a unlocking position; the woven strap is set on the guiding seat, and the extension direction of the woven strap is parallel to the sliding direction of the sliding seat; when the claw is in the locking position, the claw presses against the woven strap to achieve the positioning of the sliding seat and the guiding seat; when the claw is in the unlocking position, the claw disengages from the woven strap to release the positioning between the sliding seat and the guiding seat; the sliding seat is equipped with an operating member, which is used for user operation to push the claw from the locking position to the unlocking position.

According to an embodiment of the present disclosure, the claw comprises a first unidirectional pawl and a second unidirectional pawl, wherein the first unidirectional pawl and the second unidirectional pawl are arranged at intervals along the sliding direction of the sliding seat, wherein the first unidirectional pawl is operable to lock the forward sliding of the sliding seat, and the second unidirectional pawl is operable to lock the backward sliding of the sliding seat; when the operating member is operated, the operating member presses against the first unidirectional pawl and the second unidirectional pawl to pivot to the unlocking position, so as to release the lock of sliding of the sliding seat; alternatively, the operating member can be swingably mounted on the sliding seat; the claw comprises a first unidirectional pawl and a second unidirectional pawl, which are arranged at intervals along the sliding direction of the sliding seat. The first unidirectional pawl is used to operatively lock the forward sliding of the sliding seat, and the second unidirectional pawl is used to operatively lock the backward sliding of the sliding seat; when the operating member is operated to swing forward, the operating member presses against the first unidirectional pawl to pivot to the unlocking position, so as to release the lock of the forward sliding of the sliding seat; when the operating member is operated to swing backwards, the operating member presses against the second unidirectional pawl to pivot to the unlocking position, so as to release the lock of the backward sliding of the sliding seat

According to an embodiment of the present disclosure, the carrier body is protrudingly provided with two sets of guiding ribs, which are located on the left and right sides of the guiding seat, respectively. The guiding rib is provided with a supporting surface for supporting the end of the connecting rod, and the shape of the supporting surface is consistent with the motion trajectory of the connecting rod; each set of guiding ribs includes at least two guiding ribs, and the restraint strap hole extends in the front-rear direction. At least two guiding ribs are arranged on the left and right sides of the restraint strap holes to guide the restraint strap to slide back and forth along the restraint strap holes. The restraint strap holes are two long holes arranged at intervals along the front-rear direction, and the buckle is threaded into the restraint strap. The two ends of the restraint strap pass through the two restraint strap holes respectively and are both connected to the connecting member; the end of the restraint strap is connected with a connecting ring, which is provided with a connecting hole. The connecting hole includes a first hole part and a second hole part that are connected to each other. The first hole part is used for threading and connecting the restraint strap, and the second hole part is used for threading the connecting rod; the aperture of the second hole is greater than or equal to the outer diameter of the connecting rod, and the width of the connection between the second hole part and the first hole part is smaller than the outer diameter of the connecting rod.

According to an embodiment of the present disclosure, the carrier is a child safety seat, a child stroller, a child chair, a child rocking chair, a child swing, or a pet cage, and the restraint strap is such a restraint strap used to restrain the riding object.

From the above technical solution, it can be seen that the advantages and positive effects of the carrier and child safety seat provided in the present disclosure are:

The child safety seat provided in the present disclosure includes a seat and a restraint strap mechanism; the restraint strap mechanism includes a restraint strap, an adjusting component, and a locking component; the restraint strap is threaded through the restraint strap hole, and the upper end of the restraint strap is connected to a first buckle, while the lower end thereof is connected to the connecting member of the adjusting component; the adjusting component is set inside the seat part and includes a connecting member and a guiding member; the guiding member has a guiding surface that extends obliquely from front to rear and downward, and the connecting member can slide along the guiding surface to change the length of the restraint strap extending out of the restraint strap hole; the locking component is set on the seat part to position the connecting member on the guiding surface. Through the above design, when the restraint strap moves forward with the connecting member, it moves upward at the same time, causing the extension position of the restraint strap on the seat part to move forward and the extension length thereof to be extended. When the restraint strap moves backward with the connecting member, it moves downward at the same time, causing the extension position of the restraint strap on the seat part to move backward and the extension length thereof to be shortened. Therefore, the present disclosure utilizes the sliding of the connecting member to achieve real-time adjustment of the extension length and front and rear positions of the restraint strap. At the same time, the locking component is used to lock the restraint strap when the restraint strap is adjusted to any position, which can better adapt to children of different body sizes and has the advantages of simple structure and convenient operation.

### BRIEF DESCRIPTION OF THE DRAWINGS

By considering the following detailed description of the preferred embodiments of the present disclosure in conjunction with the accompanying drawings, the various objectives, features, and advantages of the present disclosure will become more apparent. The accompanying drawings are only exemplary illustrations of the present disclosure and are not necessarily drawn to scale. In the accompanying drawings, the same reference numerals always indicate the same or similar components. Wherein,

FIG. 1 is a perspective view of a child safety seat in a state according to an exemplary embodiment;

FIG. 2 is an enlarged schematic diagram of part A in FIG. 1;

FIG. 3 is a perspective view of the child safety seat shown in FIG. 1 in another state;

FIG. 4 is an enlarged schematic diagram of part B in FIG. 3;

FIG. 5 is a schematic cross-sectional view taken along the line L1-L1 in FIG. 1;

FIG. 6 is an enlarged schematic diagram of part C in FIG. 5;

FIG. 7 is a schematic cross-sectional view taken along the line L2-L2 in FIG. 3;

FIG. 8 is an enlarged schematic diagram of part E in FIG. 7;

FIG. 9 is a perspective view of FIG. 3 from another perspective;

FIG. 10 is an enlarged schematic diagram of part F in FIG. 9;

FIG. 11 is a perspective view of the child safety seat shown in FIG. 1 in another state;

FIG. 12 is an enlarged schematic diagram of part G in FIG. 11;

FIG. 13 is a perspective view of a partial structure of FIG. 11;

FIG. 14 is an enlarged schematic diagram of part H in FIG. 13;

FIG. 15 is a partial cross-sectional schematic diagram of the child safety seat according to another exemplary embodiment;

FIG. 16 is an enlarged schematic diagram of part I in FIG. 15;

FIG. 17 is a perspective view of the child safety seat in a state according to another exemplary embodiment;

FIG. 18 is an enlarged schematic diagram of part J in FIG. 17;

FIG. 19 is a perspective view of the child safety seat shown in FIG. 17 in another state;

FIG. 20 is an enlarged schematic diagram of part K in FIG. 19;

FIG. 21 is a schematic cross-sectional view taken along the line L3-L3 in FIG. 17;

FIG. 22 is an enlarged schematic diagram of part M in FIG. 21;

FIG. 23 is a schematic cross-sectional view taken along the line L4-L4 in FIG. 19;

FIG. 24 is an enlarged schematic diagram of part N in FIG. 23;

FIG. 25 is an enlarged schematic diagram of part O in FIG. 24;

FIG. 26 is a perspective view of FIG. 17 from another perspective;

FIG. 27 is an enlarged schematic diagram of part P in FIG. 26;

FIG. 28 is a perspective view of a partial structure of the child safety seat shown in FIG. 17;

FIG. 29 is a schematic three-dimensional exploded diagram of FIG. 28;

FIG. 30 is an enlarged schematic diagram of part Q in FIG. 29;

FIG. 31 is a perspective view of the pawl shown in FIG. 28;

FIG. 32 is a partial cross-sectional schematic diagram of the child safety seat according to another exemplary embodiment;

FIG. 33 is an enlarged schematic diagram of part R in FIG. 32.

### REFERENCE NUMERALS

100. seat; 110. seat part; 111. first through slot; 113. insert slot; 115. guiding rib; 116. restraint strap hole; 120. backrest part; 200. restraint strap; 201. end part; 210. first buckle; 211. buckle engaging part; 220. connecting ring; 221. connecting hole; 2211. first hole part; 2212. second hole part; 310. first rotation shaft; 311. rotation wheel; 320. guiding seat; 321. fixing part; 3211. fixing body; 3212. assembly end; 3213. second through slot; 322. guiding part; 3221. first guiding slot; 323. stiffening connection rod; 324. connecting member; 330. first gear; 340. first rack; 410. connecting rod; 420. second rack; 430. second rotation shaft; 431. rotation wheel; 440. guiding seat; 441. first guiding slot; 450. second gear; 510. connecting rod; 520. guiding seat; 521. first guiding slot; 522. connecting column; 523. bottom wall; 524. side wall; 530. sliding seat; 5301. upper seat body; 5302. lower seat body; 531. second guiding slot; 532. operating member; 5321. swing shaft; 5322. abutting part; 533. third rotation shaft; 534. closing board; 535. through hole; 540. claw; 541. ratchet; 542. elastic member; 550. woven strap; 600. base; D1. sliding direction; D2. movement direction; D3. swing direction

### DETAILED DESCRIPTION

The existing restraint strap adjustment solutions used in child safety seats have the disadvantages of complex structure and convenient operation, which causes inconvenience to users' usage. Typical embodiments that embody the features and advantages of the present disclosure will be described in detail in the following illustrations. It should be understood that the present disclosure may have various changes in different embodiments without departing from the scope of the present disclosure, and the description and accompanying drawings are essentially for illustration purposes, not to limit the present disclosure.

In the following description of different exemplary embodiments of the present disclosure, reference is made to the accompanying drawings, which form a part of the present disclosure, and in which different exemplary structures, systems, and steps that may implement various aspects of the present disclosure are shown by way of example. It should be understood that other specific schemes of components, structures, exemplary devices, systems, and steps may be used, and structural and functional modifications may be made without departing from the scope of the present disclosure. Moreover, although the terms “above”, “between”, “within”, etc. may be used in this specification to describe different exemplary features and elements disclosed herein, these terms are used only for convenience herein, for example, according to the direction of the examples described in the accompanying drawings. Nothing in this description should be construed as requiring a specific three-dimensional orientation of the structure to fall within the scope of the present disclosure.

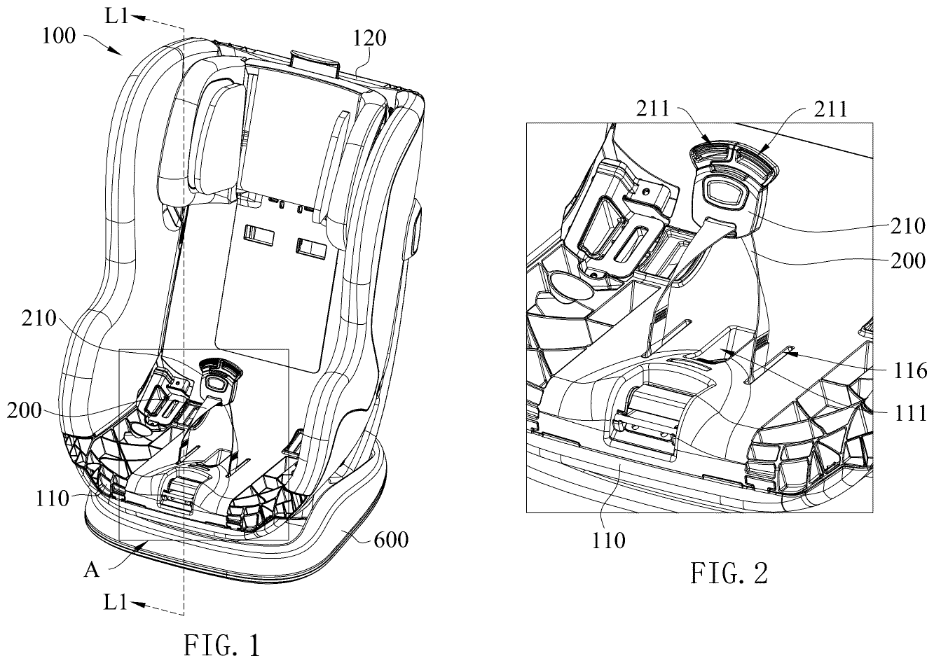

Referring to FIGS. 1 to 33, the present disclosure provides a carrier. The carrier includes a carrier body and a restraint strap adjustment mechanism. The carrier may be a child safety seat, a child stroller, a child chair, a child rocking chair, a child swing, or a pet cage, etc. The carrier body may be a closed or semi-closed housing made of hard materials such as polyester ethylene. The restraint strap may be a shoulder strap or a restraint strap used to restrain a child, or a restraint strap such as a traction rope connected to a pet collar, which is not limited herein. A restraint strap hole that runs through the surface of the carrier body is provided. The restraint strap adjustment mechanism includes a restraint strap, an adjusting component, and a locking component. The restraint strap is threaded through the restraint strap hole, with the upper end of the restraint strap exposed to the outside of the carrier body (such as the outside of the closed housing), and the lower end located inside the carrier body and connected to the connecting member of the adjusting component. The adjusting component is provided inside the carrier body and includes a connecting member and a guiding member. Wherein, the guiding member has a guiding surface that extends obliquely from front to rear and downward, and the connecting member can slide along the guiding surface to change the length of the restraint strap extending out of the restraint strap hole. The locking component is provided inside or outside the carrier body, and is used to position the connecting member in an operable manner on the guiding surface.

According to an embodiment of the present disclosure, the locking component is a combination of a claw and a restraint strap, or a combination of a gear and a rack. The restraint strap adjustment mechanism may also include an operating member for unlocking the locking component.

Referring to FIG. 1, it representatively shows a perspective view of the child safety seat in a state according to the present disclosure. In this exemplary embodiment, the child safety seat provided in the present disclosure is illustrated by an example of being applied to a car safety seat. It would be easy for those skilled in the art to understand that various modifications, additions, substitutions, deletions, or other changes are made to the specific embodiments described below in order to apply the relevant design of the present disclosure to child safety seats in other application scenarios, and these changes are still within the scope of the principles of child safety seats provided in the present disclosure.

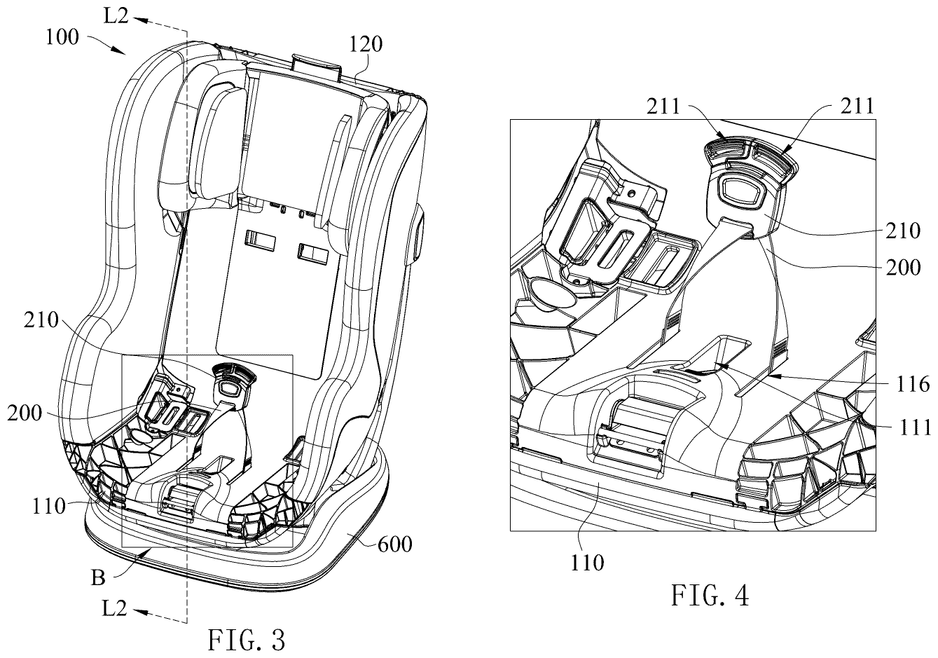

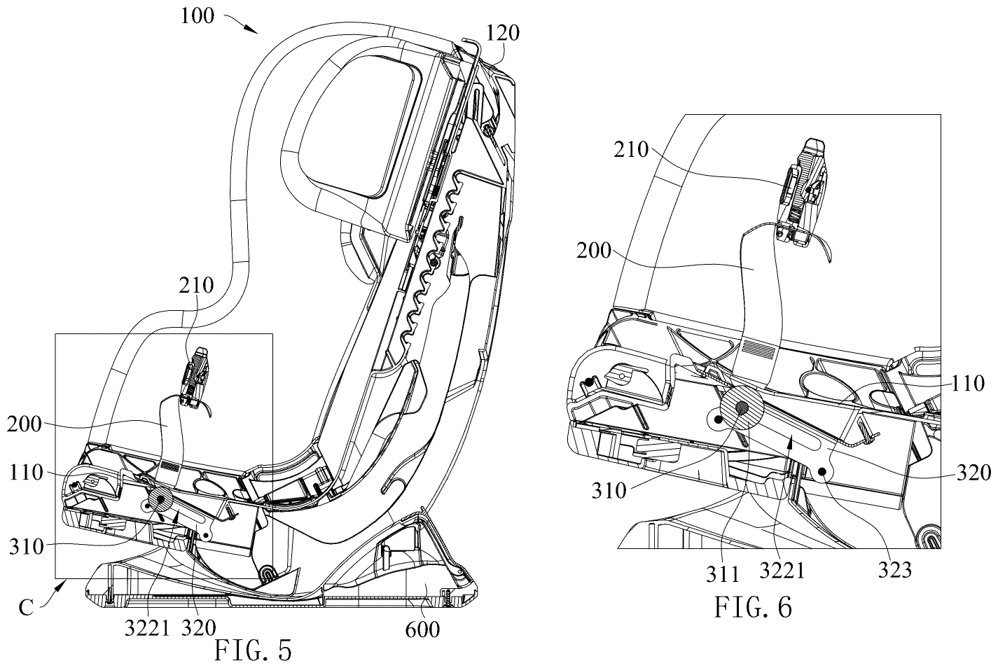

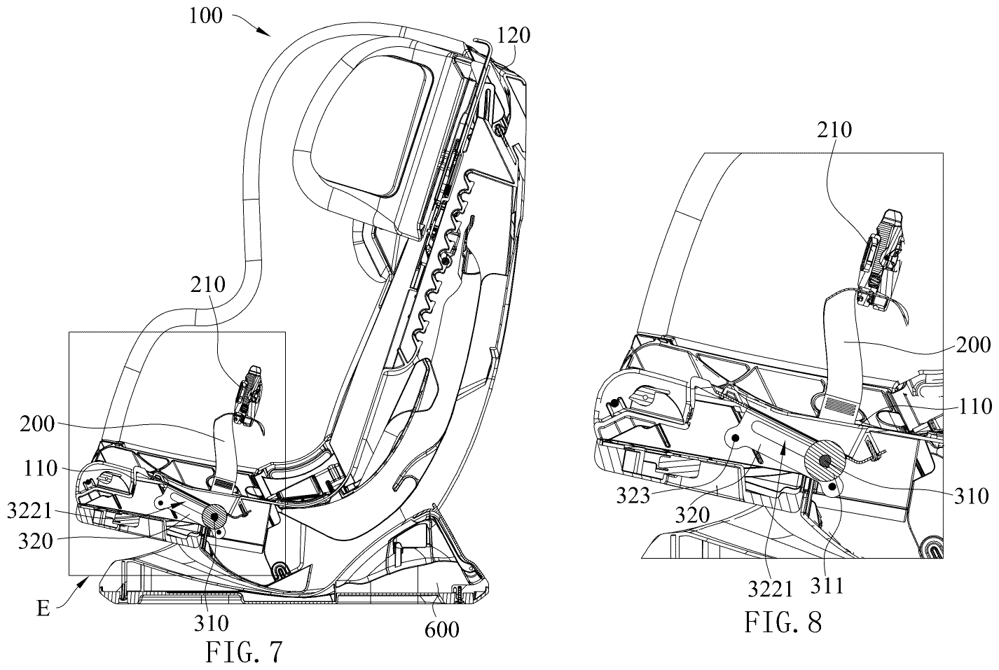

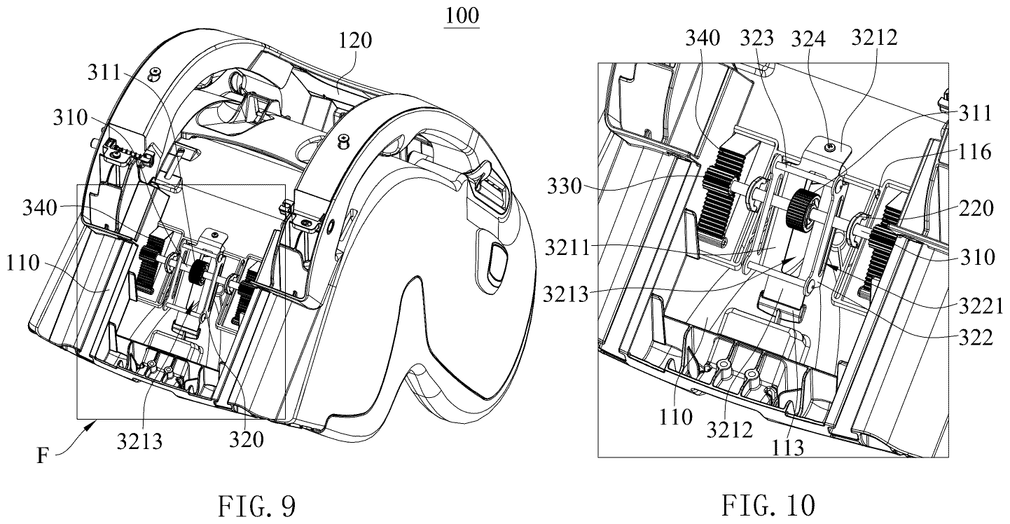

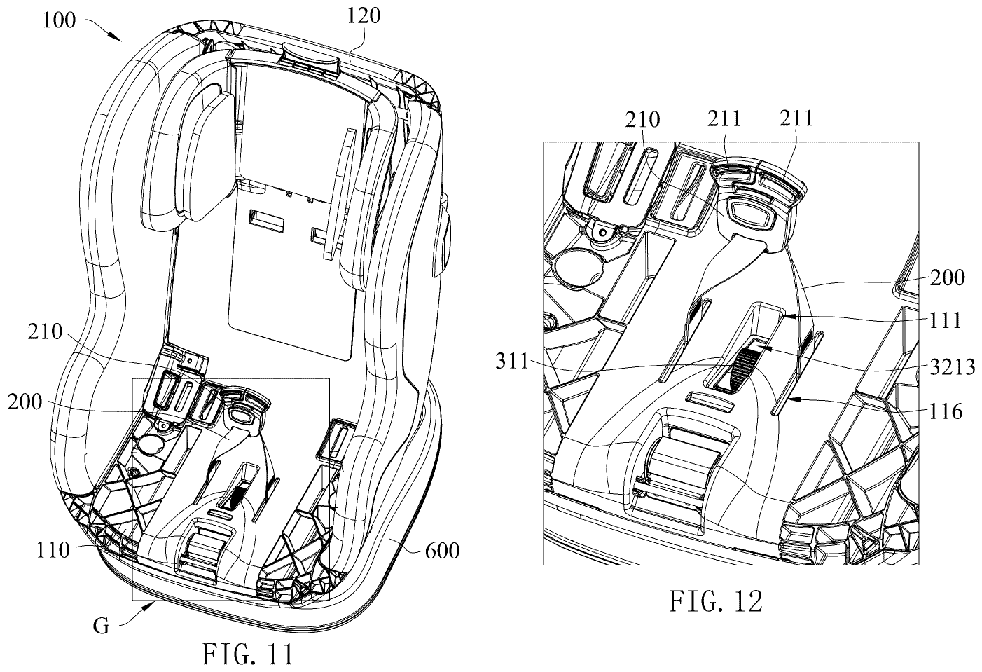

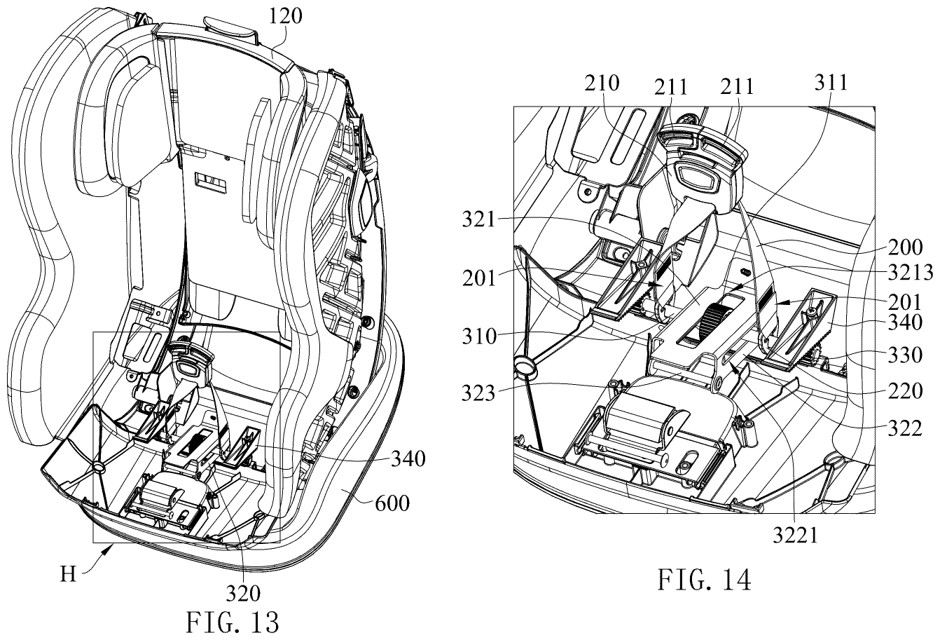

As shown in FIG. 1, in an embodiment of the present disclosure, the child safety seat of the present disclosure includes a seat and a restraint strap mechanism. Referring to FIGS. 2 to 14, FIG. 2 representatively shows an enlarged schematic diagram of part A in FIG. 1; FIG. 3 representatively shows a perspective view of the child safety seat in another state; FIG. 4 representatively shows an enlarged schematic diagram of part B in FIG. 3; FIG. 5 representatively shows a schematic cross-sectional view taken along the line L1-L1 in FIG. 1; FIG. 6 representatively shows an enlarged schematic diagram of part C in FIG. 5; FIG. 7 representatively shows a schematic cross-sectional view taken along the line L2-L2 in FIG. 3; FIG. 8 representatively shows an enlarged schematic diagram of part E in FIG. 7; FIG. 9 representatively shows a perspective view of FIG. 3 from another perspective; FIG. 10 representatively shows an enlarged schematic diagram of part F in FIG. 9; FIG. 11 representatively shows a perspective view of the child safety seat in another state; FIG. 12 representatively shows an enlarged schematic diagram of part G in FIG. 11; FIG. 13 representatively shows a perspective view of a partial structure of FIG. 11; and FIG. 14 representatively shows an enlarged schematic diagram of part H in FIG. 13. The following will provide a detailed description of the structures, connection methods, and functional relationships of the main components of the child safety seat provided in the present disclosure, in conjunction with the accompanying drawings.

As shown in FIGS. 1 to 14, in an embodiment of the present disclosure, the seat 100 includes a seat part 110 and a backrest part 120. The seat part 110 is provided with a restraint strap hole 116. The backrest part 120 is connected to the rear side of the seat part 110 and extends upwards. The backrest part 120 is equipped with shoulder straps (not shown in the drawings). The restraint strap mechanism includes a restraint strap 200, an adjusting component, and a locking component. The restraint strap 200 is threaded through the restraint strap hole 116 of the seat part 110. The upper end of the restraint strap 200 is connected to a first buckle 210, and the lower end of the restraint strap 200 is connected to a connecting member of the adjusting component described later. The first buckle 210 is used to engage (snap-fit) with a second buckle (not shown in the drawings) connected to the shoulder strap. The adjusting component is arranged inside the seat part 110, and the adjusting component includes a connecting member and a guiding member. The guiding member has a guiding surface that extends obliquely from front to rear and downward (such as the extension direction of the first guiding slot 3221 shown in FIG. 6), and the connecting member can slide along the guiding surface to change the length of the restraint strap 200 extending out of the restraint strap hole 116. For example, FIGS. 1, 2, 5, and 6 respectively show the state when the connecting member slides along the guiding member to the front end. At this time, the position where the restraint strap 200 extends out of the restraint strap hole 116 is closer to the front (i.e., relatively far away from the backrest part 120), and due to the inclined extension design of the sliding path, the connecting member is positioned higher, that is, the length of the part of the restraint strap 200 extending out of the restraint strap hole 116 is relatively longer, which can be suitable for children with larger body sizes. For example, FIGS. 3, 4, 7, and 8 respectively show the state when the connecting member slides along the guiding member to the rear end. At this time, the position where the restraint strap 200 extends out of the restraint strap hole 116 is closer to the back (i.e., relatively close to the backrest part 120), and due to the inclined extension design of the sliding path, the connecting member is positioned lower, that is, the length of the part of the restraint strap 200 extending out of the restraint strap hole 116 is shorter, which can be suitable for children with smaller body sizes. The locking component is arranged on the seat part 110, for positioning the connecting member on the guiding surface, so that the restraint strap 200 can be locked when it moves to any position with the connecting member. Through the above design, when the restraint strap 200 moves forward with the connecting member, it moves upward at the same time, causing the extension position of the restraint strap 200 on the seat part 110 to move forward and the extension length thereof to be extended. When the restraint strap 200 moves backward with the connecting member, it moves downward at the same time, causing the extension position of the restraint strap 200 on the seat part 110 to move backward and the extension length thereof to be shortened. Therefore, the present disclosure utilizes the sliding of the connecting member to achieve real-time adjustment of the extension length and the front and rear positions of the restraint strap 200, and uses meanwhile the locking component to lock the restraint strap 200 when adjusted to any position, which can better adapt to children of different body sizes and has the advantages of simple structure and convenient operation.

As shown in FIGS. 5 to 10, in an embodiment of the present disclosure, the connecting member may include a connecting rod that extends in the left-right direction, and the lower end of the restraint strap 200 is connected to the connecting rod. The guiding member includes a guiding seat 320, which is provided on the seat part 110. The guiding seat 320 is provided with a first guiding slot 3221, which extends obliquely from front to rear and downward. The guiding surface may be located on the inner peripheral wall of the first guiding slot 3221. The connecting rod is threaded through the first guiding slot 3221 and can slide along the first guiding slot 3221. In other words, the extension direction of the first guiding slot 3221 defines the sliding path of the connecting rod. Through the above design, the present disclosure utilizes the sliding fit between the connecting rod and the first guiding slot 3221 to achieve the guiding function of the connecting rod, and has a simple structure.

As shown in FIGS. 9, 10, 13, and 14, based on the design of the connecting member including the connecting rod, in an embodiment of the present disclosure, the connecting rod may be a first rotation shaft 310, and the lower end of the restraint strap 200 is rotatably connected to the first rotation shaft 310. On this basis, the locking component may include a first gear 330 and a first rack 340 that engage with each other. The first gear 330 is coaxially arranged on the first rotation shaft 310, for example, the first gear 330 and the first rotation shaft 310 may be relatively fixed. The first rack 340 is provided to the seat part 110 and extends obliquely from front to rear and downward. When the first gear 330 rotates along the first rack 340, the first rotation shaft 310 slides along the first guiding slot 3221. Wherein, the first rack 340 may be a separate component and fixedly connected to the seat part 110, or the first rack 340 may also be integrally formed to the seat part 110. Wherein, the extension direction of the first rack 340 is parallel to the extension direction of the first guiding slot 3221. Through the above design, the present disclosure can utilize the coordinated design of the first gear 330 and the first rack 340 to achieve locking (i.e., stepless adjustment) of the first rotation shaft 310 when it moves along the first guiding slot 3221 to any position, with a simple structure and a reliable locking. When in use (i.e., when a child is seated in the child safety seat and the first buckle 210 is fastened to the shoulder strap), when the vehicle decelerates urgently, the child tends to tilt forward under the action of inertia and is restrained by the shoulder strap and the restraint strap 200 on the seat part 110. The child restraint strap 200 is subjected to an upward pulling force from the shoulder strap, and the direction of the pulling force is nearly perpendicular to the extension direction of the first guiding slot 3221 (see FIG. 8). The first gear 330 is also subjected to the pulling force of the restraint strap 200, and the direction of the pulling force is nearly perpendicular to the extension direction of the first rack 340. Therefore, in the use state, the first gear 330 is tightly pressed against the surface of the first rack 340, thereby avoiding the connecting member from sliding freely in the first guiding slot 3221 and causing unexpected changes in the length of the restraint strap 200. In the non-use state, that is, when the first buckle 210 is not fastened to the shoulder strap, the user can pull the restraint strap 200 forward along the extension direction of the first guiding slot 3221, so that the first gear 330 rotates in the extension direction of the first rack 340, thereby quickly increasing the length of the restraint strap 200.

As shown in FIGS. 9, 10, 13, and 14, based on the design of the locking component including the first gear 330 and the first rack 340, in an embodiment of the present disclosure, the locking component may include two first gears 330 and two first racks 340, and the two first racks 340 are respectively located on the left and right sides of the guiding seat 320. The two first gears 330 are spaced apart from each other and arranged on the first rotation shaft 310, and the two first gears 330 respectively engage with the two first racks 340. Through the above design, the present disclosure can utilize the engaging structure of two sets of gears and racks to achieve locking of the first rotation shaft 310, improve the reliability of the locking function, and enhance the stability of the first rotation shaft 310 when sliding along the first guiding slot 3221.

As shown in FIGS. 5 to 14, based on the design of the connecting member including the connecting rod and the connecting rod being the first rotation shaft 310, in an embodiment of the present disclosure, an operating member may be provided on the first rotation shaft 310, and the seat part 110 is provided with a first through slot 111. The extension direction of the first through slot 111 is parallel to the extension direction of the first guiding slot 3221, that is, the extension direction of the first through slot 111 is parallel to the sliding path of the first rotation shaft 310. A part of the operating member exposes from the seat part 110 through the first through slot 111. The operating member is used for user operation to drive the first rotation shaft 310 to pivot, so that the first rotation shaft 310 slides along the first guiding slot 3221. Accordingly, when the user operates the operating member to move the first rotation shaft 310 along the first guiding slot 3221 (i.e., the sliding path), the extension direction of the first through slot 111 is parallel to the extension direction of the first guiding slot 3221, so that the distance between the first rotation shaft 310 and the seat part 110 remains unchanged at any position to which the first rotation shaft 310 slides, thereby ensuring the normal movement of the first rotation shaft 310 and ensuring that the operating member is always partially exposed from the first through slot 111, making it easy for the user to operate. Through the above design, the present disclosure can utilize the first through slot 111 to expose some part of the operating member, thereby improving the user's convenience in adjusting the restraint strap 200.

As shown in FIGS. 9, 10, 13, and 14, based on the design of the first rotation shaft 310 provided with the operating member, in an embodiment of the present disclosure, the locking component includes two first gears 330 and two first racks 340, the two first gears 330 are respectively set at the left and right ends of the first rotation shaft 310, and the two first gears 330 respectively engage with the two first racks 340. On this basis, the operating member may be set at the middle position of the first rotation shaft 310. Through the above design, the present disclosure can ensure that the lengths of the parts of the first rotation shaft 310 located on the left and right sides of the operating member are equal, thereby making the forces on both sides more uniform when the user adjusts the position of the first rotation shaft 310 by operating the operating member, and thereby improving the stability of the action of the first rotation shaft 310.

As shown in FIGS. 6 and 8, based on the design of the first rotation shaft 310 provided with the operating member, in an embodiment of the present disclosure, the operating member may be a rotation wheel 311, which is coaxially arranged on the first rotation shaft 310. On this basis, the rotation wheel 311 and the first rotation shaft 310 may be fixedly connected, that is, the rotation wheel 311 and the first rotation shaft 310 cannot rotate relative to each other. For example, a “keyway-key” structure may be set up in the inner hole of the rotation wheel 311 and the outer circumference of the first rotation shaft 310 to cooperate with each other, and the extension directions of the keyway and key are parallel to the extension direction of the first rotation shaft 310, that is, the left-right direction. Based on this, the relative positioning of the rotation wheel 311 and the first rotation shaft 310 in the circumferential direction can be achieved. Through the above design, the present disclosure can provide the user with the ability to rotate the rotation wheel 311 to drive the rotation of the first rotation shaft 310, thereby utilizing the engagement between the first gear 330 and the first rack 340 on the first rotation shaft 310 to achieve sliding displacement of the first rotation shaft 310 along the first guiding slot 3221. In some embodiments, when the operating member is the rotation wheel 311, the rotation wheel 311 may also be rotatably connected to the first rotation shaft 310, allowing the user to push and pull the rotation wheel 311 to achieve the sliding displacement of the first rotation shaft 310, which is not limited to the embodiment.

As shown in FIGS. 6 and 8, based on the design of the operating member being the rotation wheel 311, in an embodiment of the present disclosure, anti-slip patterns such as but not limited to anti-slip ribs, anti-slip protrusions, etc. may be provided on the periphery of the rotation wheel 311. Through the above design, the present disclosure can utilize anti-slip patterns to increase the friction force when the user operates the rotation wheel 311, thereby further improving the convenience of adjusting the restraint strap 200 and optimizing the user experience.

As shown in FIGS. 9, 10, 13, and 14, based on the design of the guiding member including the guiding seat 320, in an embodiment of the present disclosure, the guiding seat 320 may include a fixing part 321 and a guiding part 322. Specifically, the fixing part 321 is provided to the seat part 110, the guiding part 322 is connected to the fixing part 321 and extends downward, and the first guiding slot 3221 may be provided on the guiding part 322 of the guiding seat 320. In some embodiments, the guiding member may only include a structure similar to the guiding part 322, and the structure may be directly provided on the seat part 110, which is not limited to the embodiment.

For example, the part of the seat part 110 used to provide the guiding seat 320 may be a flat plate structure, and the above-mentioned first through slot 111 may be provided on the flat plate structure. On this basis, the fixing part 321 may be arranged parallel to the flat plate structure, and the guiding part 322 may be arranged perpendicular to the flat plate structure, so that the first guiding slot 3221 provided by the guiding part 322 can be used for the first rotation shaft 310 parallel to the flat plate structure to pass through and slide.

As shown in FIGS. 9, 10, 13, and 14, based on the design of the guiding seat 320 including the fixing part 321 and the guiding part 322, in an embodiment of the present disclosure, the guiding seat 320 may include two guiding parts 322, which are respectively connected to the left and right sides of the fixing part 321. Therefore, the cross-section of the guiding seat 320 is in a generally “U” shape. Both guiding parts 322 are provided with first guiding slots 3221, and the connecting rod is threaded through the two first guiding slots 3221 respectively. Through the above design, the present disclosure can utilize two guiding parts 322 to respectively arrange the first guiding slot 3221, thereby allowing the connecting rod to slide and engage with the two first guiding slots 3221, avoiding relative tilting between the connecting rod and the guiding seat 320.

As shown in FIG. 10, based on the design of the guiding seat 320 including two guiding parts 322, in an embodiment of the present disclosure, a stiffening connection rod 323 may be connected between the two guiding parts 322. Through the above design, the present disclosure can enhance the structural strength of the guiding seat 320 by the stiffening connection rod 323, improve the overall structural integrity, avoid the relative displacement of the two guiding parts 322 and therefore change the relative position of the two first guiding slots 3221, and ensure the normal sliding of the connecting rod in the two first guiding slots 3221.

As shown in FIG. 10, based on the design of the guiding seat 320 including the fixing part 321, in an embodiment of the present disclosure, the fixing part 321 may include a fixing body 3211 and two assembly ends 3212, which are respectively connected to the front and rear ends of the fixing body 3211. One of the assembly ends 3212 (such as the assembly end 3212 at the back shown in FIG. 10, which is relatively close to the backrest part 120) is connected to the seat part 110 through a connecting member 324, which may be, but is not limited to, a screw. The seat part 110 may also be equipped with an insert slot 113, and the other assembly end (such as the assembly end 3212 at the front shown in FIG. 10, which is relatively far away from the backrest part 120) is plugged into the insert slot 113. Through the above design, the present disclosure is suitable for first inserting one assembly end 3212 of the guiding seat 320 into the insert slot 113, and then fixing the other assembly end 3212 to the seat part 110 via the connecting member 324. The operation is convenient and the assembly is reliable.

As shown in FIGS. 10, 12, and 14, based on the design of the guiding seat 320 including the fixing part 321, in an embodiment of the present disclosure, the operating member (such as the rotation wheel 311 set on the first rotation shaft 310) is provided on the connecting rod, the seat part 110 is provided with the first through slot 111, and the extension direction of the first through slot 111 is parallel to the extension direction of the first guiding slot 3221. In addition, the fixing part 321 may be provided with a second through slot 3213, and the first through slot 111 and the second through slot 3213 are arranged to overlap, so as to form an operating through slot. A part of the operating member extends through the operating through slot and is exposed above the seat part 110. The operating member is used for the user to adjust the position of the connecting rod by operating.

As shown in FIGS. 9, 10, 13, and 14, based on the design of the guiding seat 320 including the fixing part 321 and the guiding part 322, in an embodiment of the present disclosure, the fixing part 321 and the guiding part 322 may be integrally bent and formed. For example, the guiding part 322 may be formed by integrally bending the guiding seat 320 made of a plate, and the part that is not bent is the fixing part 321. Through the above design, the present disclosure can simplify the manufacturing difficulty of the guiding seat 320, and meanwhile can improve the structural strength of the guiding seat 320 and reduce the number of components.

In an embodiment of the present disclosure, the material of the guiding seat 320 may be a metal material, thereby further enhancing the structural strength of the guiding seat 320.

As shown in FIGS. 2, 4, and 10, in an embodiment of the present disclosure, the seat part 110 may be provided with a restraint strap hole 116, which extends in the front-rear direction of the seat part 110. The end part 201 of the restraint strap 200 passes through the restraint strap hole 116 and extends into the seat part 110. Through the above design, the present disclosure can utilize the restraint strap hole 116 to allow the restraint strap 200 to pass through, and meanwhile can provide the guidance function for the restraint strap 200 to move with the connecting member.

As shown in FIGS. 2 and 4, in an embodiment of the present disclosure, the restraint strap 200 may be connected to the first buckle 210 through its own middle part. Accordingly, both end parts 201 of the restraint strap 200 extend into the seat part 110, and both end parts 201 are connected to the connecting member. On this basis, when the seat part 110 is provided with the restraint strap hole 116, the seat part 110 may be specifically provided with two restraint strap holes 116, and these two restraint strap holes 116 are arranged at intervals along the left-right direction of the seat part 110. The two restraint strap holes 116 are located on the left and right sides of the guiding member, respectively.

As shown in FIG. 10, in an embodiment of the present disclosure, in the case that the seat part is provided with two restraint strap holes 116 and the locking component includes two first racks 340, the two restraint strap holes 116 may be located between the left and right sides of the two first racks 340 and the guiding seat 320, respectively. Accordingly, for the restraint strap 200 connected to the first rotation shaft 310 via the connecting ring 220, its two sides in the axial direction of the first rotation shaft 310 are respectively limited by the guiding seat 320 and the first gear 330, thereby avoiding the connecting ring 220 along the first rotation shaft 310 from sliding off.

As shown in FIGS. 2 and 4, based on the design of the restraint strap 200 being connected to the first buckle 210 through its own middle part, in an embodiment of the present disclosure, the first buckle 210 may have two buckle engaging parts 211 arranged in the left-right direction, and the two buckle engaging parts 211 are respectively used to engage (snap-fit) with the second buckles of the two shoulder straps. On this basis, the restraint strap 200 extends from the front and rear sides of the first buckle 210, and the two end parts 201 of the restraint strap 200 are twisted into a left and right spaced arrangement. In another embodiment, in the case that the restraint strap 200 is connected to the first buckle 210 through its own middle part, the restraint strap may also extend from the left and right sides of the first buckle 210. At this time, the two end parts 201 of the restraint strap 200 may be arranged in a left and right spaced state without twisting. Alternatively, the restraint strap 200 may also be connected to the first buckle 210 through one end part of itself (instead of the middle part), or the restraint strap 200 may only have one end part extending into the seat part 110 and connected to the connecting member, all of which are not limited to the above embodiments.

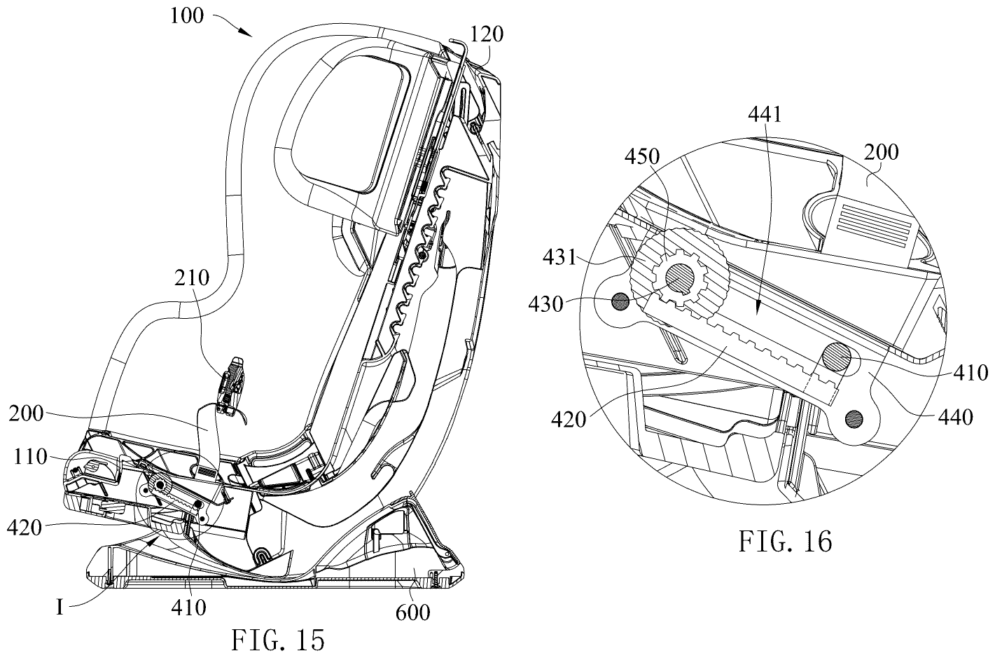

Referring to FIGS. 15 and 16, FIG. 15 representatively shows a partial cross-sectional schematic diagram of the child safety seat that can embody the principles of the present disclosure in another exemplary embodiment; and FIG. 16 representatively shows an enlarged schematic diagram of part I in FIG. 15. Wherein, in the embodiment shown in FIGS. 15 and 16, the child safety seat provided in the present disclosure adopts such a design that is partially similar to the embodiment shown in FIGS. 1 to 14. The main differences between the two embodiments will be explained below.

As shown in FIGS. 15 and 16, in an embodiment of the present disclosure, the connecting member includes a connecting rod 410, but the connecting rod 410 is not the first rotation shaft 311 used in the embodiment shown in FIGS. 1 to 14, that is, the connecting rod 410 is a non-rotatable rod. Specifically, the connecting rod 410 is connected to a second rack 420, and the second rack 420 is movable provided on the guiding seat 440. On this basis, the adjusting component may further include an operating member, which may be, for example, a second rotation shaft 430. The second rotation shaft 430 is rotatably provided on the guiding seat 440, and the second rotation shaft 430 is coaxially provided with a second gear 450, which engages with the second rack 420. Accordingly, when the user operates the second rotation shaft 430, the second gear 450 rotates and drives the second rack 420 to move through the engagement between the second gear 450 and the second rack 420, causing the connecting rod 410 to slide along the first guiding slot 441. Through the above design, the present disclosure enables the user to achieve sliding adjustment of the connecting rod 410 by only rotating the second rotation shaft 430, thereby adjusting the restraint strap 200, eliminating the step of pushing and pulling the connecting rod along the sliding path, and making the adjustment method simpler and more convenient. In addition, the present disclosure utilizes the second gear 450 and the second rack 420, which are engaged with each other, as locking components to achieve locking of the connecting rod 410 at any position to which it moves along the first guiding slot 441. The structure is simple and the locking is reliable.

As shown in FIG. 16, based on the design of the adjusting component including the second rotation shaft 430, in an embodiment of the present disclosure, an operating member may be provided on the second rotation shaft 430, and the operating member may be a rotation wheel 431, which is coaxial with the second rotation shaft 430. Wherein, the rotation wheel 431 and the second rotation shaft 430 may be fixedly connected, that is, the rotation wheel 431 and the second rotation shaft 430 cannot rotate relative to each other. Through the above design, the present disclosure can provide the user with the ability to rotate the rotation wheel 431 and drive the second rotation shaft 430 to rotate, thereby utilizing the engagement between the second gear 450 of the second rotation shaft 430 and the second rack 420 to achieve the sliding displacement of the connecting rod 410 along the first guiding slot 441.

Based on the design of the operating member being the rotation wheel 431, in an embodiment of the present disclosure, anti-slip patterns may be provided on the periphery of the rotation wheel 431. Through the above design, the present disclosure can utilize anti-slip patterns to increase the friction force when the user operates the rotation wheel 431, thereby further improving the convenience of adjusting the restraint strap 200 and optimizing the user experience.

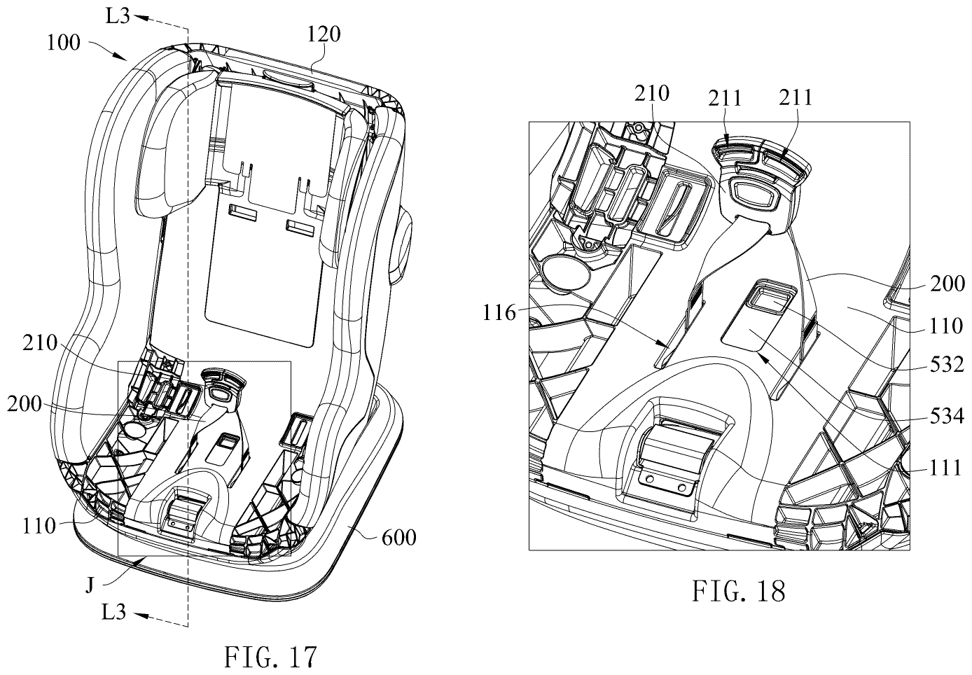

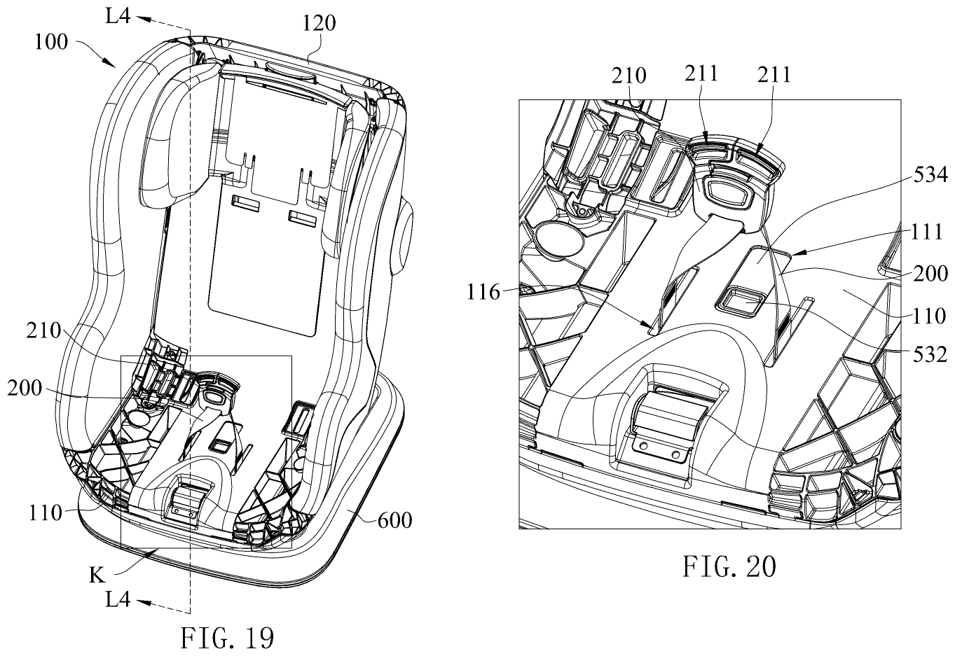

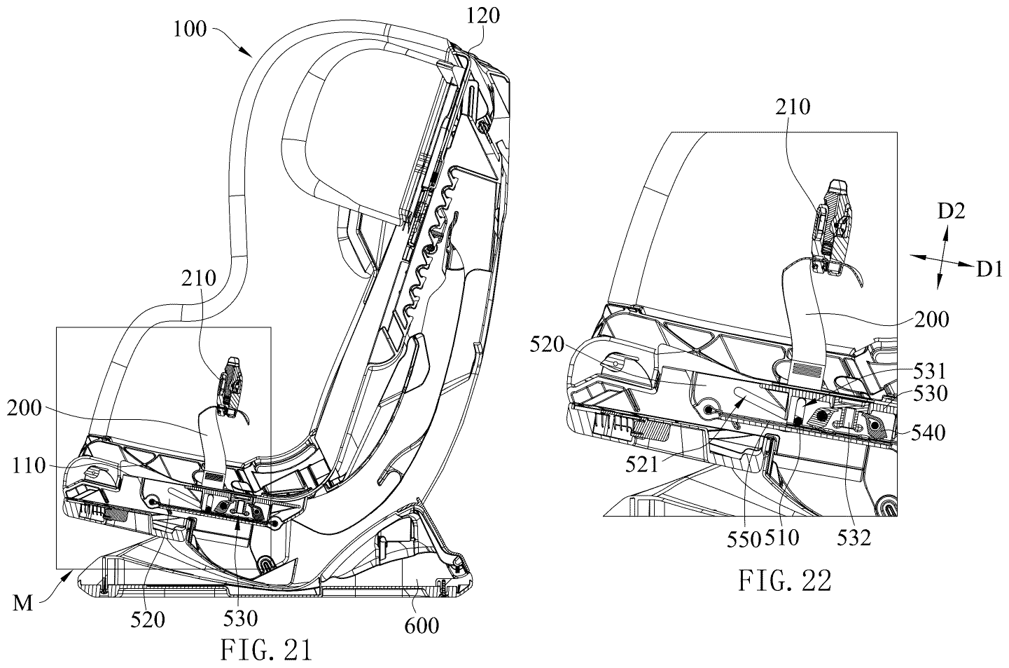

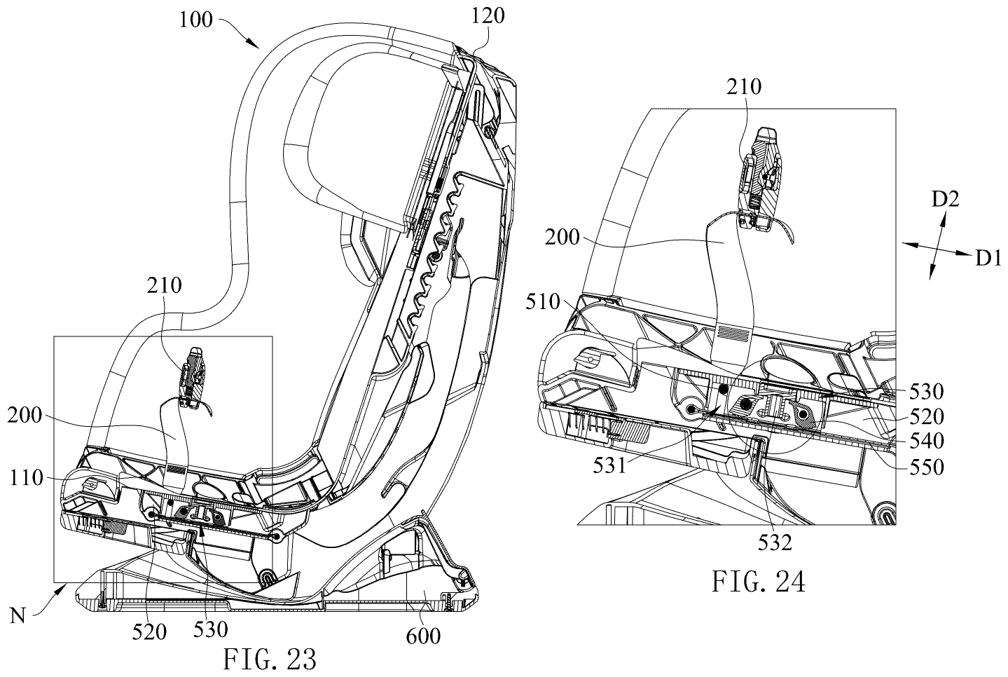

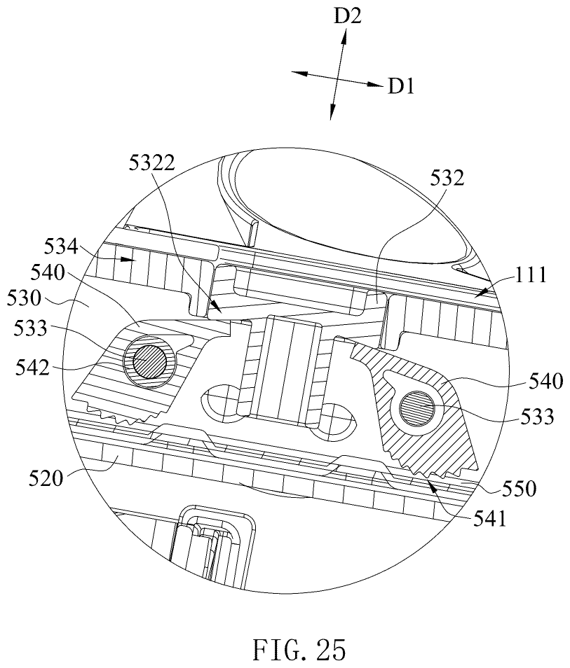

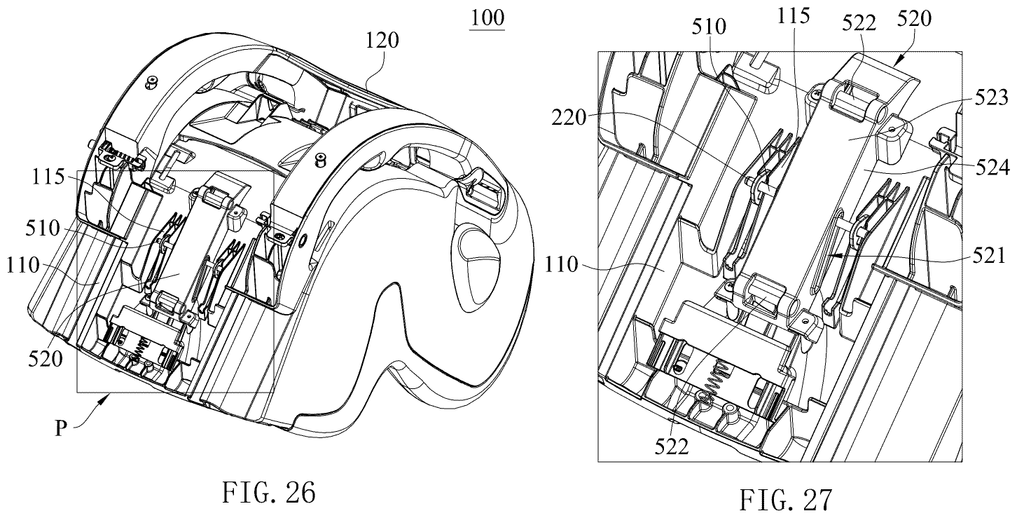

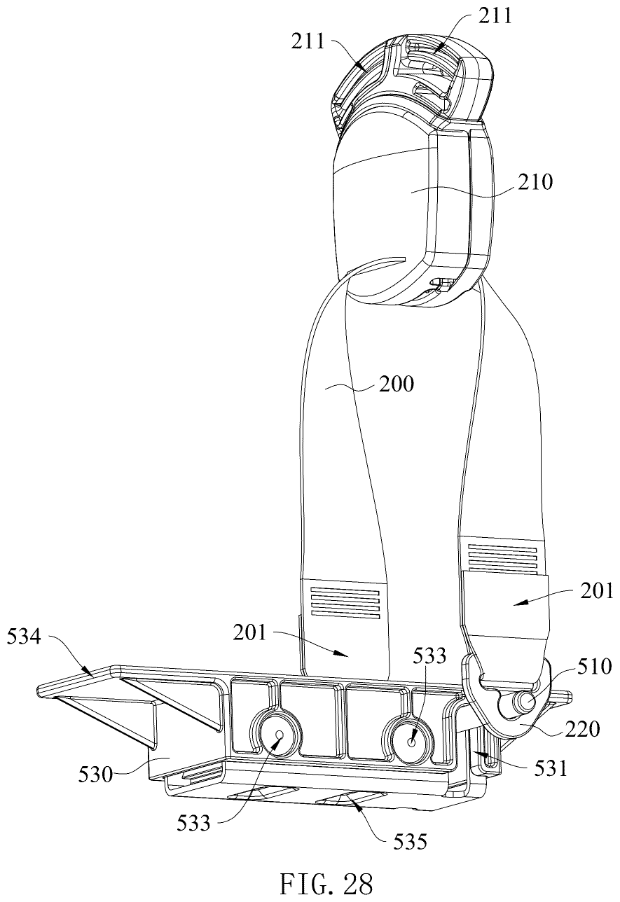

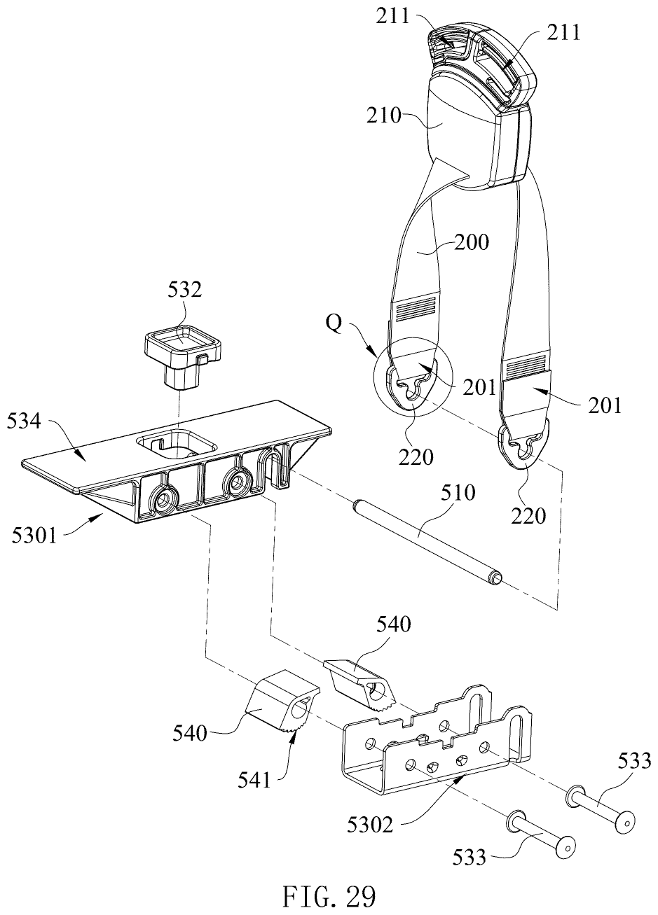

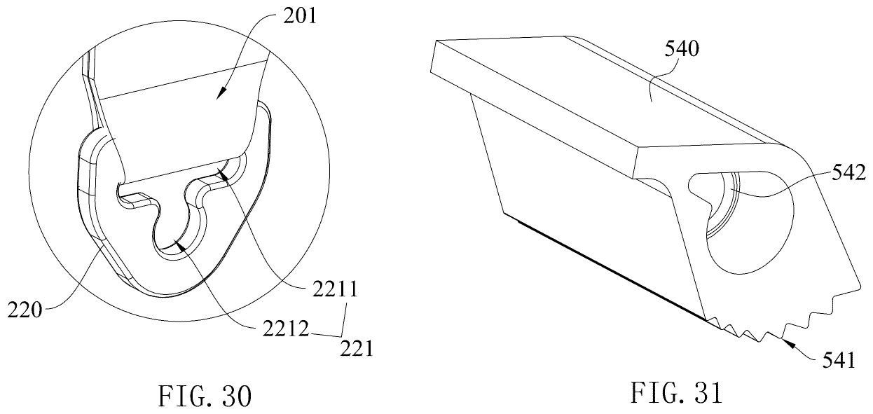

Referring to FIGS. 17 to 31, FIGS. 17 and 19 representatively show perspective views of the child safety seat that can embody the principles of the present disclosure in different states in another exemplary embodiment, respectively; FIG. 18 representatively shows an enlarged schematic diagram of part J in FIG. 17; FIG. 20 representatively shows an enlarged schematic diagram of part K in FIG. 19; FIG. 21 representatively shows a schematic cross-sectional view taken along the line L3-L3 in FIG. 17; FIG. 22 representatively shows an enlarged schematic diagram of part M in FIG. 21; FIG. 23 representatively shows a schematic cross-sectional view taken along the line L4-L4 in FIG. 19; FIG. 24 representatively shows an enlarged schematic diagram of part N in FIG. 23; FIG. 25 representatively shows an enlarged schematic diagram of part O in FIG. 24; FIG. 26 representatively shows a perspective view of FIG. 17 from another perspective; FIG. 27 representatively shows an enlarged schematic diagram of part P in FIG. 26; FIG. 28 representatively shows a perspective view of the partial structure of the child safety seat shown in FIG. 17; FIG. 29 representatively shows a schematic three-dimensional exploded diagram of FIG. 28; FIG. 30 representatively shows an enlarged schematic diagram of part Q in FIG. 29; and FIG. 31 representatively shows a perspective view of the pawl shown in FIG. 28.

As shown in FIGS. 21 to 27, in an embodiment of the present disclosure, the adjusting component may include a connecting member, a guiding seat and a sliding seat. The connecting member includes a connecting rod 510, which extends in the left-right direction, and the lower end of the restraint strap 200 is connected to the connecting rod 510. The guiding member includes a guiding seat 520, which is set on the seat part 110. The guiding seat 520 is provided with a first guiding slot 521, which extends obliquely from front to rear and downward. The connecting rod 510 is threaded through the first guiding slot 521 and can slide along the first guiding slot 521. In other words, the extension direction of the first guiding slot 521 defines the sliding path of the connecting rod 510. The sliding seat 530 is provided in the guiding seat 520, and can slide in the front-rear direction. The sliding direction of the sliding seat 530 is the front-rear direction of the seat part 110, that is, relative to the sliding direction of the sliding seat 530, the thickness direction of the connecting rod 510 (i.e., the extension direction of the first guiding slot 521) is relatively inclined from front to rear and downward. On this basis, the sliding seat 530 is provided with a second guiding slot 531, and the extension direction of the second guiding slot 531 is perpendicular to the seat surface of the seat part 110, which is the surface of the seat part 110 for children to sit on, that is such a surface defined by the front-rear direction and left-right direction of the seat part 110. Accordingly, the connecting rod 510 is also threaded through the second guiding slot 531, and the connecting rod 510 can slide along the second guiding slot 531. Specifically, the connecting rod 510 is simultaneously threaded through the first guiding slot 521 and the second guiding slot 531. When the sliding seat 530 slides along the front-rear direction of the seat part 110 within the guiding seat 520, the connecting rod 510 moves along the first guiding slot 521 between “front-up” and “rear-down”, and also moves along the second guiding slot 531 between “up” and “down”. When the locking component locks the sliding seat 530 and prevents it from sliding relative to the guiding seat 520, under the action of the first guiding slot 521 and the second guiding slot 531, the connecting rod 510 is restricted in its current position and cannot move in the up-down or front-rear direction. Through the above design, the present disclosure enables the user to implement the adjustment function by only pushing and pulling the connecting rod 510 to move, further improving operational convenience and optimizing the user experience.

When it is necessary to adjust the restraint strap 200, press down on the operating member 532, which pushes the claw 540. The claw 540 then rotates to disengage its ratchet 541 from the woven strap 550. At this time, maintain pressing down and simultaneously push the operating member 532 to drive the sliding seat 530 to slide relative to the guiding seat 520, that is, to slide relative to the seat part 110, thereby driving the connecting rod 510 to move. The first guiding slot 521 of the guiding seat 520 would push the connecting rod 510 to move along the second guiding slot 531, thereby driving the restraint strap 200 to move in the front-rear direction and the up-down direction simultaneously. This achieves the adjustment of the length and position of the restraint strap 200, which is suitable for children of different body sizes and can be a stepless adjustment, so as to more accurately meet the needs of children.

As shown in FIGS. 21 to 25, 29, and 31, in an embodiment of the present disclosure, the locking component may include a claw 540 and a woven strap 550. Specifically, the claw 540 is movably provided on the sliding seat 530 and has a locking position and an unlocking position, that is, the claw 540 can be switched between the locking position and the unlocking position through the relative movement arrangement of the sliding seat 530. The end of the claw 540 facing the woven strap 550 may be equipped with, for example, the ratchet 541. When the claw 540 is pressed against the woven strap 550, the positioning of the woven strap 550 can be achieved through the ratchet 541. The woven strap 550 is set on the guiding seat 520, and the extension direction of the woven strap 550 is parallel to the sliding direction of the sliding seat 530. The woven strap 550 may be, for example, a fiber woven strap. When in the locking position, the claw 540 presses against the woven strap 550 to achieve the positioning between the sliding seat 530 and the guiding seat 520. When in the unlocking position, the claw 540 disengages from the woven strap 550 to release the positioning between the sliding seat 530 and the guiding seat 520. The sliding seat 530 is equipped with an operating member 532, which is used for the user to operate and push the claw 540 from the locking position to the unlocking position. Through the above design, the present disclosure is able to achieve the locking between the sliding seat 530 and the guiding seat 520 by the cooperation design of the claw 540 and the woven strap 550, thereby achieving the locking of the connecting rod 510 at any position to which it moves, and the locking is reliable.

As shown in FIGS. 22, 24, and 25, based on the design of the locking component including the claw 540 and the woven strap 550, in an embodiment of the present disclosure, the sliding seat 530 may be provided with a third rotation shaft 533, and the claw 540 is rotatedly provided on the sliding seat 530 via the third rotation shaft 533. Moreover, the sliding seat 530 further includes an elastic member 542, which can be a torsion spring connected between the claw 540 and the third rotation shaft 533. The elastic member 542 is able to apply a force to the claw 540 to move towards the direction of the locking position. Through the above design, the present disclosure can utilize the third rotation shaft 533 to achieve the rotational arrangement of the claw 540 in the sliding seat 530. At the same time, the torsion spring can be used as the elastic member 542 to provide pre-tension force, ensuring that the locking component can always maintain the locking state when the user does not touch the operating member 532, improving the stability of the restraint strap 200, and ensuring personnel safety.

As shown in FIGS. 17 to 20, based on the design of the sliding seat 530 provided with the operating member 532, in an embodiment of the present disclosure, the seat part 110 may be provided with the first through slot 111, and the extension direction of the first through slot 111 is parallel to the sliding direction of the sliding seat 530 (i.e., the front-rear direction of the seat part 110), while the first through slot 111 exposes a part of the sliding seat 530. On this basis, when the sliding seat 530 slides to both ends in its sliding direction, the operating member 532 is exposed in the first through slot 111. Through the above design, the present disclosure can ensure that when the sliding seat 530 slides to any position, the operating member 532 is exposed to the seat part 110, for ensuring user operation of the operating member 532.

As shown in FIGS. 17, 19, 28, and 29, based on the design of the seat part 110 provided with the first through slot 111, in an embodiment of the present disclosure, the top of the sliding seat 530 is provided with a closing board 534, and the area of the closing board 534 is larger than that of the first through slot 111. Moreover, in the case that the sliding seat 530 slides to any position, the first through slot 111 is always completely closed by the closing board 534. Through the above design, the present disclosure is able to use the closing board 534 to close the first through slot 111, preventing dust, debris, or liquids from entering the seat part 110 through the first through slot 111, and at the same time, improving the aesthetics of the child safety seat.

As shown in FIGS. 21 to 25, based on the design of the sliding seat 530 provided with the operating member 532, in an embodiment of the present disclosure, the operating member 532 can perform linear motion relative to the sliding seat 530, and the movement direction D2 of the operating member 532 is perpendicular to the sliding direction D1 of the sliding seat 530 (i.e., the front-rear direction of the seat part 110). On this basis, in the locking state, one end of the claw 540 facing away from the woven strap 550 may come into abut an abutting part 5322 of the operating member 532. When the operating member 532 moves towards the woven strap 550, the abutting part 5322 presses against the claw 540 to rotate, causing the ratchet 541 of the claw 540 to disengage from the woven strap 550. Accordingly, when the user needs to adjust the position of the restraint strap 200, the user only needs to press the operating member 532 down to unlock the locking component, and then push and pull the operating member 532 in the front-rear direction while maintaining pressing the operating member 532 down, so as to adjust the position of the restraint strap 200.

As shown in FIGS. 21 to 25, 28, and 29, based on the design of the locking component including the claw 540, in an embodiment of the present disclosure, the claw 540 may include two unidirectional pawls, namely a first unidirectional pawl and a second unidirectional pawl, which are arranged at intervals along the sliding direction of the sliding seat 530 (i.e., the front-rear direction of the seat part 110). The first unidirectional pawl is used to operably lock the forward sliding of the sliding seat 530, and the second unidirectional pawl is used to operably lock the backward sliding of the sliding seat 530; when the operating member is operated, the operating member presses against the first unidirectional pawl and the second unidirectional pawl to pivot to the unlocking position, thereby unlocking the sliding of the sliding seat 530. For example, the operating member 532 with two abutting parts 5322 can generally form a “T” shape as shown in the attached drawings. Through the above design, the present disclosure can further enhance the locking effect of the locking structure with the combination of the claw 540 and the woven strap 550.

As shown in FIGS. 22, 24, and 27, based on the design of the locking component including the woven strap 550, in an embodiment of the present disclosure, the front and rear ends of the guiding seat 520 may be respectively connected to the connecting column 522, which may be a rivet, and the woven strap 550 may be connected between the two connecting columns 522. Wherein, the extension direction of the connecting column 522 is parallel to the left-right direction of the seat part 110, and since the two connecting columns 522 are located at the front and rear ends of the guiding seat 520 respectively, the relative arrangement direction of the two connecting columns 522 is parallel to the front-rear direction of the seat part 110, that is, parallel to the sliding direction of the sliding seat 530. Accordingly, when the sliding seat 530 slides to any position, the effective contact positioning between the ratchet 541 of the claw 540 and the woven strap 550 can be ensured.

Based on the design of the adjusting component including the guiding seat 520 and the sliding seat 530, in an embodiment of the present disclosure, a guiding structure (not shown in the drawings), such as but not limited to a guiding slot, a guiding rail, a slide rail, etc., may be provided inside the guiding seat 520 to guide and cooperate with the sliding seat 530. Through the above design, the present disclosure can provide the guidance function for the sliding seat 530 through a guiding mechanism, ensuring the sliding direction of the sliding seat 530 within the guiding seat 520.

As shown in FIGS. 26 and 27, based on the design of the adjusting component including the guiding seat 520, in an embodiment of the present disclosure, the guiding seat 520 may have a box-shaped structure with a top opening, and the guiding seat 520 has a bottom wall 523 and a side wall 524. On this basis, the guiding seat 520 may be connected to the bottom surface of the seat part 110 through its top opening, and the sliding seat 530 is accommodated in the box cavity of the box-shaped structure described above. The side walls 524 on both sides of the guiding seat 520 are provided with the first guiding slot 521, and the left and right ends of the connecting rod 510 respectively extend from the left and right sides of the guiding seat 520. Through the above design, the guiding seat 520 in the present invention is designed as a box-shaped structure, can thereby reduce the exposure of internal components (such as the sliding seat 530, the woven strap 550, etc.) of the guiding seat 520 to the external environment, provide protection for related components, and improve the service life.

As shown in FIGS. 26 and 27, based on the design of the adjusting component including the guiding seat 520, in an embodiment of the present disclosure, the left and right ends of the connecting rod 510 respectively extend from the left and right sides of the guiding seat 520. On this basis, the seat part 110 may be provided with two sets of guiding ribs 115, which are located on the left and right sides of the guiding seat 520. The guiding rib 115 is provided with a supporting surface for supporting the end part of the connecting rod 510, and the shape of the supporting surface is consistent with the motion trajectory of the connecting rod 510. Through the above design, the present disclosure can provide support for the connecting rod 510 through the guiding rib 115, and make the sliding action of the connecting rod 510 smoother and more stable.

As shown in FIGS. 26 and 27, based on the design of the seat part 110 provided with the guiding ribs 115, in an embodiment of the present disclosure, each set of guiding ribs 115 may include at least two guiding ribs 115, and the restraint strap hole 116 extends in the front-rear direction. At least two guiding ribs 115 are set on the left and right sides of the restraint strap hole 116 to guide the restraint strap 200 to slide forward and backward along the restraint strap hole 116. Accordingly, the ends of the connecting rod 510 are supported by the at least two guiding ribs 115. Through the above design, the present disclosure can improve the reliability of the support function, while also enhancing the stability of the connecting rod 510 when sliding along the supporting surface of the guiding rib 115. On this basis, when the end part 201 of the restraint strap 200 is connected to the end part of the connecting rod 510 (e.g., via the connecting ring 220), the end part 201 of the restraint strap 200 and related connecting members (e.g., the connecting ring 220) may also be partially located between adjacent guiding ribs 115. In other words, when the seat part 110 is provided with a restraint strap hole 116 for the restraint strap 200 to pass through, a plane parallel to both the front-rear direction and the left-right direction of the seat part 110 is taken as the reference plane. On the reference plane, the orthographic projection of the restraint strap hole 116 is located between the orthographic projections of two adjacent guiding ribs 115. Based on this, the present disclosure can avoid any interference between the guiding rib 115 and the restraint strap 200 and related connecting components, and can use the space formed between two adjacent guiding ribs 115 to provide guidance and limiting functions for the restraint strap 200.

As shown in FIGS. 28 to 30, in an embodiment of the present disclosure, the restraint strap hole 116 may be two long holes arranged at intervals and extending in the front-rear direction. The first buckle 210 is threaded through the restraint strap 200, and the two ends of the restraint strap 200 pass through the two restraint strap holes 116, respectively, and are both connected to the connecting member. The end of the restraint strap 200 (such as the end part 201 shown in the drawings) may be connected to the connecting ring 220, which may be made of, for example, metal material. Wherein, the connecting ring 220 is provided with a connecting hole 221, which includes a first hole part 2211 and a second hole part 2212 that are connected to each other. The first hole part 2211 is used for threading and connecting the restraint strap 200 (specifically, the end part 201), for example, by means of sewing process to connect with the restraint strap 200. The second hole part 2212 is used for the connecting rod 510 to pass through. On this basis, the aperture of the second hole part 2212 may be greater than or equal to the outer diameter of the connecting rod 510, and the width of the connection between the second hole part 2212 and the first hole part 2211 may be smaller than the outer diameter of the connecting rod 510. Through the above design, the present disclosure utilizes one connecting hole 221 that simultaneously provides for the assembly of both the restraint strap 200 and the connecting rod 510, which can reduce the processing difficulty of the connecting ring 220. Meanwhile, the present disclosure can prevent the connecting rod 510 from moving from the second hole part 2212 to the first hole part 2211, further enhancing the stability of the connecting rod 510. It should be noted that the above description of the connection ring 220 is based on the embodiments shown in FIGS. 17 to 31. It should be understood that in other embodiments that conform to the design concept disclosed herein, the end part 201 of the restraint strap 200 may also be connected to the connecting member (such as the first rotation shaft 310 and the connecting rod 410 mentioned above) through the same or similar design as the connecting ring 220, and is not limited to this embodiment.

As shown in FIGS. 28 and 29, in an embodiment of the present disclosure, the sliding seat 530 may include an upper seat body 5301 and a lower seat body 5302. The upper seat body 5301 and the lower seat body 5302 are up-down assembled to form a cavity that accommodates the claw 540. Wherein, each of the upper seat body 5301 and the lower seat body 5302 is provided with a through slot that runs through in the left-right direction, and the positions of two through slots overlap to jointly form the second guiding slot 531 of the sliding seat 530.

As shown in FIGS. 28 and 29, based on the design of the sliding seat 530 including the upper seat body 5301 and the lower seat body 5302, the cross-section of the upper seat body 5301 may be in a “n” shape, and the cross-section of the lower seat body 5302 may be in a “U” shape. Therefore, the side walls of the upper seat body 5301 are located on the outer sides (inner sides are also possible) of the side walls of the lower seat body 5302, and the side walls of the both may be fixedly connected through a fixing component. For example, the fixing component may be a rivet, and further, the rivet may also serve as the third rotation shaft 533 for rotatedly arranging the claw 540 on the sliding seat 530.

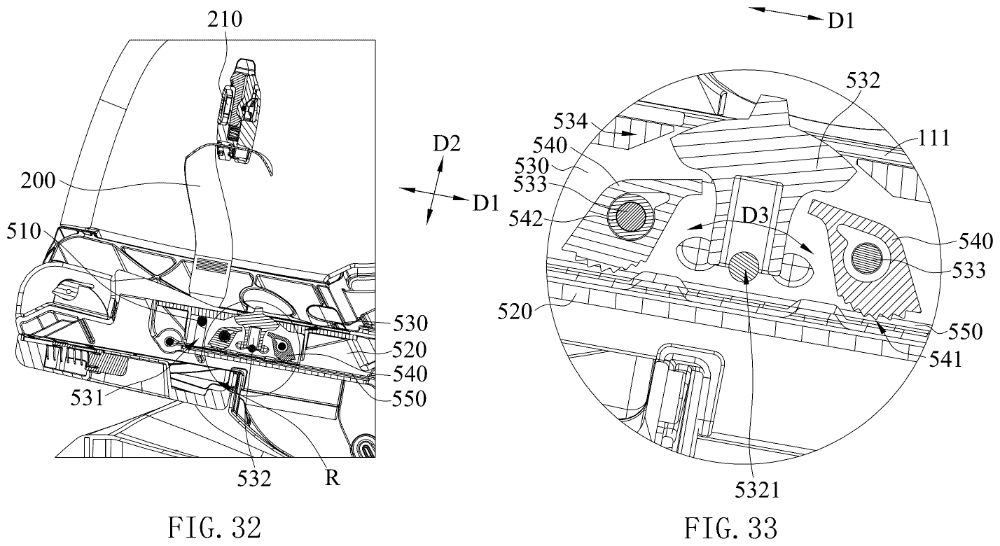

Referring to FIGS. 32 and 33, FIG. 32 representatively represents a partial cross-sectional schematic diagram of the child safety seat that can embody the principles of the present disclosure in another exemplary embodiment; FIG. 33 representatively shows an enlarged schematic diagram of part R in FIG. 32. Wherein, in the embodiment shown in FIGS. 32 and 33, the child safety seat provided in the present disclosure adopts such a design that is partially similar to the embodiment shown in FIGS. 17 to 31. The main differences between the two embodiments will be explained below.

As shown in FIGS. 32 and 33, in an embodiment of the present disclosure, the sliding seat 530 is provided with the operating member 532, but the operating member 532 does not use the pressing operation method used in the embodiment shown in FIGS. 17 to 31, that is, the movement direction of the operating member 532 is not a straight line direction perpendicular to the sliding direction of the sliding seat 530. Specifically, the operating member 532 is swingably provided on the sliding seat 530, and the axial direction of the swinging of the operating member 532 is in the left-right direction. Based on this, the swinging direction D3 of the sliding member 532 may be referred to FIG. 33. On this basis, taking the example of the claw 540 including two unidirectional pawls (i.e., the first unidirectional pawl and the second unidirectional pawl), when the operating member is operated to swing forward, the operating member presses against the first unidirectional pawl to pivot to the unlocking position, so as to unlock the forward sliding of the sliding seat 530. When the operating member is operated to swing backward, the operating member presses against the second unidirectional pawl to pivot to the unlocking position, so as to unlock the backward sliding of the sliding seat 530. Accordingly, when the user needs to adjust the position of the restraint strap 200, the user only needs to push the operating member 532 forward or backward to achieve single-side release of the locking component, and then push or pull the operating member 532 forward or backward while maintaining pushing on the operating member 532, to achieve the position adjustment of the restraint strap 200.

As shown in FIG. 33, based on the design of the operating member 532 being set on the sliding seat 530 in a swinging manner, in an embodiment of the present disclosure, the operating member 532 may have an arc-shaped knob-like structure, for example. Furthermore, a protrusion may be provided at the middle position of the outer side surface of the operating member 532 (i.e., the arc-shaped surface of the operating member 532 facing away from the claw 540 and partially exposed in the first through slot 111), thereby further optimizing the convenience of the turning operation and enhancing the user experience. In addition, by controlling the height of the protrusion, the protrusion may also limit the swing amplitude of the operating member 532. Specifically, when the operating member 532 swings to both sides, the protrusion may interfere with the slot wall of the slot of the sliding seat 530 that exposes the operating member 532, thereby achieving a limiting function, avoiding an excessive swinging amplitude of the operating member 532, and ensuring that the claw 540 and elastic member 542 are not excessively compressed and damaged.

It should be noted that the child safety seat shown in the accompanying drawings and described in the description are only a few examples among many types of child safety seats that adopt the principles disclosed herein. It should be clearly understood that the principles of the present disclosure are by no means limited to any details or components of the child safety seat shown in the drawings or described in the description.

For example, as shown in FIG. 1, in an embodiment of the present disclosure, the child safety seat provided in the present disclosure further includes a base 600, the seat 100 is provided on the base 600, and the seat 100 can slide on the base 600. The sliding trajectory of the seat 100 is, for example, an arc-shaped path, which can achieve the adjustment of the sitting posture of the seat 100.

In summary, the child safety seat provided in the present disclosure includes the seat 100 and the restraint strap mechanism; the restraint strap mechanism includes the restraint strap 200, the adjusting component, and the locking component; the restraint strap 200 is threaded through the restraint strap hole 116, and the upper end of the restraint strap 200 is connected to the first buckle 210, while the lower end thereof is connected to the connecting member of the adjusting component; the adjusting component is arranged inside the seat part 110 and includes the connecting member and the guiding member; the guiding member includes the guiding surface that extends obliquely from front to rear and downward, and the connecting member can slide along the guiding surface to change the length of the restraint strap 200 extending out of the restraint strap hole 116; the locking component is set on the seat part 110 to position the connecting member on the guiding surface. Through the above design, when the restraint strap 200 moves forward with the connecting member, it moves upward at the same time, causing the extension position of the restraint strap 200 on the seat part 110 to move forward and the extension length to be extended. When the restraint strap 200 moves backward with the connecting member, it moves downward at the same time, causing the extension position of the restraint strap 200 on the seat part 110 to move backward and the extension length to be shortened. Therefore, the present disclosure utilizes the sliding of the connecting member to achieve real-time adjustment of the extension length and front and rear positions of the restraint strap 200, and uses the locking component to lock the restraint strap 200 at any adjusted position, which can better adapt to children of different body sizes and has the advantages of simple structure and convenient operation.

The above provides a detailed description and/or illustration of exemplary embodiments of the child safety seat provided in the present disclosure. However, the disclosed embodiments are not limited to the specific embodiments described herein. On the contrary, the components and/or steps of each embodiment may be used independently and separately from the other components and/or steps described herein. Each component and/or step of an embodiment may also be combined with other components and/or steps of other embodiments. When introducing the elements/components/etc. described and/or illustrated herein, the terms “one”, “a (an)”, and “the” are used to indicate the presence of one or more elements/components/etc. The terms “including”, “comprising”, and “having” are used to indicate open-ended inclusion and refer to the possibility of additional elements/components/etc. in addition to the listed ones. In addition, the terms “first” and “second” used in the claims and description are only for marking purposes and are not numerical limitations on their subject matter.

Although the child safety seat provided in the present disclosure has been described based on different specific embodiments, those skilled in the art will recognize that modifications can be made to the implementation of the present disclosure within the spirit and scope of the claims.

What is claimed is:

1. A carrier comprising:
a carrier body, provided with a restraint strap hole; and
a restraint strap adjustment mechanism, comprising:
a restraint strap, threaded through the restraint strap hole, and an upper end of the restraint strap being exposed to outside of the carrier body, a lower end of the restraint strap being inside the carrier body and being connected to a connecting member;
an adjusting component, arranged inside the carrier body and comprising a connecting member and a guiding member, the guiding member being provided with a guiding surface that extends obliquely from front to rear and downward relative to a seat surface of the carrier body, the connecting member being configured to slide along the guiding surface so as to change a length of the restraint strap extending out of the restraint strap hole; and
a locking component, provided on the carrier body, for operably positioning the connecting member on the guiding surface.

2. The carrier according to claim 1, wherein,
the guiding member comprises a guiding seat, which is arranged on the carrier body and is provided with a first guiding slot, and the first guiding slot extends obliquely from front to rear and downward, the guiding surface is on an inner peripheral wall of the first guiding slot;
the connecting member comprises a connecting rod, which is threaded through the first guiding slot and is configured to slide along the first guiding slot.

3. The carrier according to claim 2, wherein,
the locking component comprises a first gear and a first rack that engage with each other, the first gear is coaxially arranged on the connecting rod, the first rack is arranged on the carrier body and extends obliquely from front to rear and downward, and in the case that the first gear rotates along the first rack, the connecting rod slides along the first guiding slot.

4. The carrier according to claim 3, wherein,
the connecting rod is provided with an operating member, the carrier body is provided with a first through slot, an extension direction of the first through slot is parallel to an extension direction of the first guiding slot, a part of the operating member exposes the carrier body through the first through slot, the operating member is used for user operation to drive the connecting rod to pivot, so that the connecting rod slides along the first guiding slot.

5. The carrier according to claim 2, wherein,
the connecting rod is connected to a second rack, which is movably provided on the guiding seat;
the adjusting component further comprises an operating member, which is rotatably arranged on the guiding seat, and is coaxially provided with a second gear, which engages with the second rack;
in the case that the user operates the operating member, the second gear rotates and drives the second rack to move, so that the connecting rod slides along the first guiding slot.

6. The carrier according to claim 3, wherein,
the connecting rod is connected to a second rack, which is movably provided on the guiding seat;
the adjusting component further comprises an operating member, which is rotatably arranged on the guiding seat, and is coaxially provided with a second gear, which engages with the second rack;
in the case that the user operates the operating member, the second gear rotates and drives the second rack to move, so that the connecting rod slides along the first guiding slot.

7. The carrier according to claim 2, wherein,
the adjusting component further comprises a sliding seat, which is arranged in the guiding seat and is configured to slide in a front-rear direction, the sliding seat is provided with a second guiding slot, and the extension direction of the second guiding slot is perpendicular to a seat surface of the carrier body;
the connecting rod is further threaded through the second guiding slot and is configured to slide along the second guiding slot.

8. The carrier according to claim 7, wherein,
the locking component comprises a claw and a woven strap, the claw is movably arranged on the sliding seat and has a locking position and an unlocking position, the woven strap is arranged on the guiding seat, and the extension direction of the woven strap is parallel to a sliding direction of the sliding seat;
in the case that the claw is in the locking position, the claw presses against the woven strap to position the sliding seat and the guiding seat; in the case that the claw is in the unlocking position, the claw disengages from the woven strap to unlock the positioning between the sliding seat and the guiding seat;
the sliding seat is provided with an operating member, which is used for user operation to push the claw to move from the locking position to the unlocking position.

9. The carrier according to claim 8, wherein,
the claw comprises a first unidirectional pawl and a second unidirectional pawl, which are arranged at intervals along the sliding direction of the sliding seat, the first unidirectional pawl is used to operatively lock forward sliding of the sliding seat, and the second unidirectional pawl is used to operatively lock backward sliding of the sliding seat; in the case that the operating member is operated, the operating member presses against the first unidirectional pawl and the second unidirectional pawl to pivot to the unlocking position, so as to release the lock on the sliding of the sliding seat.

10. The carrier according to claim 8, wherein,
the operating member is swingably arranged on the sliding seat; the claw comprises a first unidirectional pawl and a second unidirectional pawl, which are arranged at intervals along the sliding direction of the sliding seat, the first unidirectional pawl is used to operatively lock forward sliding of the sliding seat, and the second unidirectional pawl is used to operatively lock backward sliding of the sliding seat; in the case that the operating member is operated to swing forward, the operating member presses against the first unidirectional pawl to pivot to the unlocking position, so as to release the lock on the forward sliding of the sliding seat; in the case that the operating member is operated to swing backward, the operating member presses against the second unidirectional pawl to pivot to the unlocking position, so as to release the lock on the backward sliding of the sliding seat.

11. The carrier according to claim 8, wherein,
the carrier body is projectingly provided with two sets of guiding ribs, which are on left and right sides of the guiding seat, the guiding rib is provided with a supporting surface for supporting an end part of the connecting rod, and a shape of the supporting surface is consistent with a motion trajectory of the connecting rod; each set of guiding ribs includes at least two guiding ribs, the restraint strap hole extends in the front-rear direction, the at least two guiding ribs are arranged on left and right sides of the restraint strap hole to guide the restraint strap to slide forward and backward along the restraint strap hole.

12. The carrier according to claim 8, wherein,
the restraint strap holes are two long holes at intervals extending in the front-rear direction, a buckle is threaded through the restraint strap, two ends of the restraint strap pass through the two restraint strap holes respectively and are both connected to the connecting member; the end of the restraint strap is connected with a connecting ring, which is provided with a connecting hole, the connecting hole comprises a first hole part and a second hole part that are connected to each other, the first hole part is used for threading and connecting the restraint strap, and the second hole part is used for threading the connecting rod.

13. The carrier according to claim 8, wherein,
an aperture of the second hole part is greater than or equal to an outer diameter of the connecting rod, and a width of a connection between the second hole part and the first hole part is smaller than the outer diameter of the connecting rod.

14. The carrier according to claim 1, wherein,
the carrier is a child safety seat, a child stroller, a child chair, a child rocking chair, a child swing or a pet cage, and the restraint strap is a restraint strap used to restrain a riding object.

15. A child safety seat comprising:
a seat comprising a seat part and a backrest part, wherein the seat part is provided with a restraint strap hole; and
a restraint strap mechanism, comprising:
a restraint strap, threaded through the restraint strap hole, and an upper end of the restraint strap is connected to a first buckle, a lower end of the restraint strap is connected to a connecting member;
an adjusting component, arranged inside the seat part and comprising a connecting member and a guiding member; the guiding member being provided with a guiding surface that extends obliquely from front to rear and downward, the connecting member being configured to slide along the guiding surface to change a length of the restraint strap extending out of the restraint strap hole; and
a locking component, provided on the seat part, for positioning the connecting member on the guiding surface.

16. The child safety seat according to claim 15, wherein,
the guiding member comprises a guiding seat, which is arranged on the seat part and is provided with a first guiding slot, and the first guiding slot extends obliquely from front to rear and downward, the guiding surface is on an inner peripheral wall of the first guiding slot;
the connecting member comprises a connecting rod, which is threaded through the first guiding slot and is configured to slide along the first guiding slot.

17. The child safety seat according to claim 16, wherein,
the locking component comprises a first gear and a first rack that engage with each other, the first gear is coaxially arranged on the connecting rod, the first rack is arranged on the seat part and extends obliquely from front to rear and downward, and in the case that the first gear rotates along the first rack, the connecting rod slides along the first guiding slot.

18. The child safety seat according to claim 17, wherein,
the connecting rod is provided with an operating member, the seat part is provided with a first through slot, an extension direction of the first through slot is parallel to an extension direction of the first guiding slot, a part of the operating member exposes the seat part through the first through slot, the operating member is used for user operation to drive the connecting rod to pivot, so that the connecting rod slides along the first guiding slot.

19. The child safety seat according to claim 16, wherein,
the connecting rod is connected to a second rack, which is movably provided on the guiding seat;
the adjusting component further comprises an operating member, which is rotatably arranged on the guiding seat, and is coaxially provided with a second gear, which engages with the second rack;
in the case that the user operates the operating member, the second gear rotates and drives the second rack to move, so that the connecting rod slides along the first guiding slot.

20. The child safety seat according to claim 16, wherein,
the adjusting component further comprises a sliding seat, which is arranged in the guiding seat and is configured to slide in a front-rear direction, the sliding seat is provided with a second guiding slot, and the extension direction of the second guiding slot is perpendicular to a seat surface of the seat part;
the connecting rod is further threaded through the second guiding slot and is configured to slide along the second guiding slot.
